(19) United States
(12) Patent Application Publication
(10) Pub. No.: US 2022/0188304 A1
(43) Pub. Date: Jun. 16, 2022

(54) METHOD AND SYSTEM FOR HANDLING QUERY IN IOT NETWORK

(71) Applicant: Samsung Electronics Co., Ltd., Suwon-si (KR)

(72) Inventors: Siba Prasad SAMAL, Bangalore (IN); Ankit JAIN, New Delhi (IN); Ravi NANJUNDAPPA, Bengaluru (IN)

(21) Appl. No.: 17/545,482

(22) Filed: Dec. 8, 2021

Related U.S. Application Data
(63) Continuation of application No. PCT/KR2021/016239, filed on Nov. 9, 2021.

(30) Foreign Application Priority Data
Dec. 11, 2020 (IN) 202041053969

(51) Int. Cl. G06F 16/242; G10L 15/26; G10L 15/22; G06F 16/2457

(52) U.S. Cl. CPC G06F 16/2425; G10L 15/26; G10L 2015/223; G06F 16/24575; G10L 15/22

(57) ABSTRACT

A method for handling a query using a first Internet of Things (IoT) device is provided. The method includes retrieving, by a first IoT device, information related to events corresponding to second IoT devices, upon receiving a query from a user. The method includes modifying the query based on the information related to the events, and executing the modified query to provide a response to the user, upon not receiving a response for the query from the server. The method includes modifying a response received for the query based on the information related to the events, and delivering the modified response to the user, upon receiving the response for the query from the server. The method includes responding to follow-up queries received from the server for providing a response to the user, upon receiving the follow-up queries for the query from the server.

### CROSS-REFERENCE TO RELATED APPLICATION(S)

This application is a continuation application, claiming priority under § 365(c), of an International application No. PCT/KR2021/016239, filed on Nov. 9, 2021, which is based on and claims the benefit of an Indian Complete patent application number 202041053969, filed on Dec. 11, 2020, in the Indian Intellectual Property Office, the disclosure of which is incorporated by reference herein in its entirety.

### BACKGROUND

### 1. Field

The disclosure relates to electronic devices. More particularly, the disclosure relates to a method and a system for handling a query in an Internet of Things (IoT) network.

### 2. Description of Related Art

An intelligent automated assistant, also referred as a virtual assistant, provides an improved interface between a human and a computing device such as a computer, a smartphone, IoT devices and the like. The virtual assistant allows users to interact with the IoT devices in an IoT network based on a query of the user, where the query can be a natural language, in spoken and/or text forms. The virtual assistant interprets an intent of the user from the query, operationalizes the intent into tasks, executes services providing by the IoT devices and the virtual assistant to perform the tasks, and provides a response to the user. The virtual assistant is allowed to control the IoT devices for executing the services providing by the IoT devices. In few cases, the virtual assistant is able to interpret the intent of the user from the query without an assistance of the server. But, generally the assistance of the server is essential for the virtual assistant to interpret the intent of the user from the query. However, in many cases, the query alone is not sufficient to clearly define the intent of the user and the tasks to be performed.

In an example scenario, consider the user instructs the virtual assistant to “order food after movie” while the user is watching a movie. In this scenario, the virtual assistant is unable to decide a time of an end of the movie to order the food. Further, the virtual assistant is unable to decide the food that the user preferred to order. An existing method allows the virtual assistant to order the food based on a previous food ordering history of the user or a current context of devices and applications. But, the food ordered as per the existing method may not be necessarily the user preferred one, which tampers a user experience in ordering the food online Moreover, the food may deliver to the user while the user is watching the movie, which also tampers a user experience in watching the movie. Another existing method allows the virtual assistant to ask follow-up questions to the user to clearly define the intent of the user, which also tampers the user experience in watching the movie. Thus, it is desired to address the above-mentioned shortcomings or at least provide a useful alternative.

The above information is presented as background information only to assist with an understanding of the disclosure. No determination has been made, and no assertion is made, as to whether any of the above might be applicable as prior art with regard to the disclosure.

### SUMMARY

In accordance with an aspect of the disclosure, a method for handling a query in an IoT network is provided. The method includes receiving, by a first IoT device in the IoT network, the query from a user of the first IoT device. Further, the method includes retrieving, by the first IoT device, information related to at least one event corresponding to at least one second IoT device in the IoT network. Further, the method includes performing, by the first IoT device, at least one of modifying the query based on the information related to the at least one event, and executing the modified query to provide at least one response to the user, receiving at least one response for the query, modifying the at least one response received for the query based on the information related to the at least one event, and delivering the at least one modified response to the user, detecting that the query is related to at least one previous query received from the user based on the information related to the at least one event, detecting at least one response provided for the at least one previous query received from the user in response to detecting that the query is related to the at least one previous query received from the user, executing the query to provide at least one follow-up response based on at least one of the at least one previous query received from the user and the at least one response provided for the at least one previous query, and sending the query to a server, receiving at least one follow-up query from the server, providing at least one follow-up response for the least one follow-up query to the server based on the information related to the at least one event, and providing at least one response to the user in response to receiving at least one response from the server, where the server sends the at least one response to the first IoT device by executing the at least one follow-up response.

In an embodiment, where retrieving, by the first IoT device, the information related to the at least one event, includes identifying, by the first IoT device, the at least one second IoT device in the IoT network semantically related to the query, detecting, by the first IoT device, the at least one event corresponding to the at least one second IoT device within a temporal window, and retrieving, by the first IoT device, the information related to the at least one event from the at least one second IoT device based on the temporal window.

In an embodiment, where identifying, by the first IoT device, the at least one second IoT device in the IoT network semantically related to the query received from the first IoT device, includes extracting, by the first IoT device, a plurality of features from the query, and identifying, by the first IoT device, the at least one second IoT device in the IoT network by semantically matching the plurality of features with information of the at least one second IoT device.

In an embodiment, where the information related to the at least one event includes at least one of a list of identifiers of IoT devices used during the at least one event, a person involved in the at least one event, a category of the at least one event, actions performed in the event, an intent of the at least one event, an application used during the at least one event, a time stamp of the at least one event, and a metadata of the at least one event.

In an embodiment, where modifying, by the first IoT device, the query based on the information related to the at least one event, includes determining, by the first IoT device, a context of the query based on the information related to the at least one event, classifying, by the first IoT device, the query based on a user intent and a history associated with the query, bifurcating, by the first IoT device, the query to identify places in the query where the information related to the at least one event can be added, augmenting, by the first IoT device, the query with the information related to the at least one event in the identified places of the query, and reformulating, by the first IoT device, the augmented query based on the context of the query and the classification of the query using a machine learning based model.

In an embodiment, where provide at least one follow-up response, includes identify a context and intention of the at least one follow-up query received from the server, map the identified context and intention with information related to the at least one event, and generate the at least one follow-up response to provide an answer to the follow-up query based on the mapping.

In an embodiment, where receiving, by the first IoT device, the at least one response for the query, includes sending, by the first IoT device, the query to the server, and receiving, by the first IoT device, the at least one response for the query from the server, where the server generates the at least one response for the query in response to executing the query.

In an embodiment, where executing, by the first IoT device, the modified query to provide at least one response to the user, includes sending, by the first IoT device, the modified query to server, and receiving, by the first IoT device, the at least one response for the modified query from the server, where the server generates the at least one response for the modified query in response to executing the modified query.

In an embodiment, where modifying, by the first IoT device, the at least one response received for the query based on the information related to the at least one event, includes classifying, by the first IoT device, the query into pre-trained categories, identifying, by the first IoT device, a relevant context of the response to the IoT network and the second IoT device based on a category of the query, identifying, by the first IoT device, relevant entities in the response based on the category of the query, segregating, by the first IoT device, the relevant entities, resolving, by the first IoT device, dependencies in the response based on the information related to the at least one event, the relevant entities and the relevant context of the response, and reformulating, by the first IoT device, the response by adding new data obtained due to resolving the dependencies.

In accordance with another aspect of the disclosure, a first IoT device for handling the query in the IoT network is provided. The first IoT device includes a query engine, a memory, a processor, where the query engine is coupled to the memory and the processor. The query engine is configured to receive the query from the user of the first IoT device. The query engine is configured to retrieve the information related to the at least one event corresponding to the at least one second IoT device in the IoT network. The query engine is configured to perform at least one of modifying the query based on the information related to the at least one event, and executing the modified query to provide the at least one response to the user, receiving the at least one response for the query, modifying the at least one response received for the query based on the information related to the at least one event, and delivering the at least one modified response to the user, detecting that the query is related to the at least one previous query received from the user based on the information related to the at least one event, detecting the at least one response provided for the at least one previous query received from the user in response to detecting that the query is related to the at least one previous query received from the user, executing the query to provide the at least one follow-up response based on at least one of the at least one previous query received from the user and the at least one response provided for the at least one previous query, and sending the query to the server, receiving the at least one follow-up query from the server, providing the at least one follow-up response for the least one follow-up query to the server based on the information related to the at least one event, and providing at least one response to the user in response to receiving at least one response from the server, where the server sends the at least one response to the first IoT device by executing the at least one follow-up response.

In accordance with another aspect of the disclosure, a method for handling the query in the IoT network is provided. The method includes receiving, by the first IoT device in the IoT network, the query. The method includes performing, by the first IoT device (100), a first processing of the query within the IoT network based on events occurred in the IoT network over a pre-defined time. The method includes performing, by a server, a second processing of the query. The method includes feeding, by the first IoT device (100), an output of the first processing to the second processing for assisting the server in preparing a response to the query.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of a system for handling a query in an IoT network, according to an embodiment of the disclosure;

FIG. 2 is a block diagram of a query engine of a first IoT device in a system for handling a query, according to an embodiment of the disclosure;

FIG. 3 is a block diagram of a query engine of a server in a system for handling a query, according to an embodiment of the disclosure;

FIGS. 4A, 4B, 4C, and 4D are flow diagrams illustrating a method of handling a query using a system, according to various embodiments of the disclosure;

FIG. 5 is a flow diagram illustrating operations in a method performed by a query analyzer of a first IoT device for retrieving information related to events corresponding to second IoT devices in an IoT network, according to an embodiment of the disclosure;

FIG. 6 is a flow diagram illustrating operations in a method performed by a temporal event data aggregator of a first IoT device for retrieving information related to events from second IoT devices based on a temporal window, according to an embodiment of the disclosure;

FIG. 7 is a flow diagram illustrating operations in a method performed by an associative event filtration engine of a first IoT device for filtering events, according to an embodiment of the disclosure;

FIG. 8 is a flow diagram illustrating operations in a method performed by a query rephrasing engine of a first IoT device for modifying a query, according to an embodiment of the disclosure;

FIG. 9 is a flow diagram illustrating operations in a method performed by a follow-up auto-reply assistor of a first IoT device for providing follow-up responses to a server, according to an embodiment of the disclosure;

FIG. 10 is a flow diagram illustrating operations in a method performed by a personalized data augmenter of a first IoT device for providing a personalized response to a user, according to an embodiment of the disclosure;

FIGS. 11A, 11B, 11C, 11D, and 11E illustrate an example scenario of handing a query related to suggesting a recipe to the user based on information related to events, according to various embodiments of the disclosure; and

FIGS. 12A, 12B, 12C, 12D, and 12E illustrate an example scenario of handing a query related to ordering a food for a user based on information related to events, according to various embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiments herein provide a method for handling a query in an IoT network. The method includes receiving, by a first IoT device in the IoT network, the query from a user of the first IoT device. Further, the method includes retrieving, by the first IoT device, information related to at least one event corresponding to at least one second IoT device in the IoT network. Further, the method includes performing, by the first IoT device, at least one of: modifying the query based on the information related to the at least one event, and executing the modified query to provide at least one response to the user, receiving at least one response for the query, modifying the at least one response received for the query based on the information related to the at least one event, and delivering the at least one modified response to the user, detecting that the query is related to at least one previous query received from the user based on the information related to the at least one event, detecting at least one response provided for the at least one previous query received from the user in response to detecting that the query is related to the at least one previous query received from the user, executing the query to provide at least one follow-up response based on at least one of: the at least one previous query received from the user and the at least one response provided for the at least one previous query, and sending the query to a server, receiving at least one follow-up query from the server, providing at least one follow-up response for the least one follow-up query to the server based on the information related to the at least one event, and providing at least one response to the user in response to receiving at least one response from the server, wherein the server sends the at least one response to the first IoT device by executing the at least one follow-up response.

Another aspect of the disclosure is to retrieve information related to events performed using IoT devices in the IoT network, in response to receiving a query (e.g. voice query) from a user.

Another aspect of the disclosure is to enrich the query received from the user using the information related to the events for providing a response for the modified query to the user.

Another aspect of the disclosure is to terminate execution of the query of the user and execute the modified query to provide the response for the modified query to the user, in response to receiving the modified query.

Another aspect of the disclosure is to personalize a response received for the query from a server using the information related to the events, and delivering the personalized response to the user.

Another aspect of the disclosure is to generate and send follow-up queries to a first IoT device which receives the query from the user.

Another aspect of the disclosure is to generate and send follow-up responses for the follow-up queries to the server, where the server uses the follow-up responses for generating a final response that to deliver to the user.

Unlike existing methods and systems, the proposed method allows the first IoT device to modify the query with additional details, where the additional details are obtained using the information related to the at least one event corresponding to the at least one second IoT device. Therefore, the server connected to the first IoT device is able to clearly define the intent of the user based on the modified query the and generates an appropriate response for the user, which improves a user experience in using services providing by the IoT devices.

The proposed method allows first IoT device to provides the follow-up responses to the server for the follow-up query from the server based on the information related to the at least one event. Thus, the server reaches a point to clearly define the intent of the user using the follow-up responses and generates the appropriate response for the user, which improves the user experience in using the services providing by the IoT devices.

Moreover, the first IoT device is configured to personalize the response received from the server based on the information related to the at least one event to provide a personalized response to the user, which improves the user experience in using the services providing by the IoT devices.

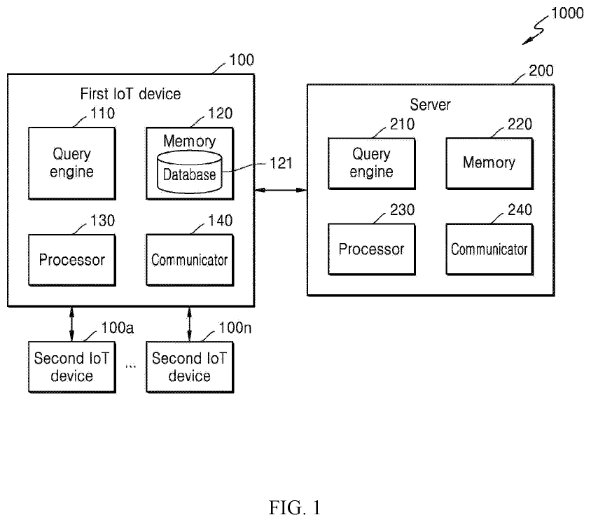

Referring now to the drawings, and more particularly to FIGS. 1 to 3, 4A to 4D, 5 to 10, 11A to 11E, and 12A to 12E, there are shown preferred embodiments.

FIG. 1 is a block diagram of a system for handling a query in an IoT network, according to an embodiment of the disclosure.

Referring to FIG. 1, examples for a query are a voice query, a voice command, a text query, and the like. In an embodiment, a system 1000 includes a first IoT device 100, at least one second IoT device 100a-100n and a server 200 (e.g. a cloud server). The first IoT device is connected to the at least one second IoT device 100a-100n and the server 200. In an embodiment, the first IoT device 100 is a master IoT device in the IoT network to control and access the at least one second IoT device 100a-100n. In an embodiment, hardware components and functioning of the first IoT device 100 and the at least one second IoT device 100a-100n are similar

A IoT device in the IoT network that receives the query of a user operates as the first IoT device 100, whereas the remaining IoT devices in the IoT network operates as the at least one second IoT device 100a-100n. Examples for the first IoT device 100 and the at least one second IoT device 100a-100n are, but not limited to, a Virtual Assistant (VA), a smart phone, a tablet computer, a personal digital assistance (PDA), a Television (TV), a Smart watch, a Fridge, an IoT camera and the like. In an embodiment, the first IoT device 100 includes a query engine 110, a memory 120, a processor 130, and a communicator 140. In an embodiment, the server 200 includes a query engine 210, a memory 220, a processor 230, and a communicator 240

The query engine 110 is configured to receive the query from the user of the first IoT device 100. Further, the query engine 110 is configured to send the query to the server 200 for obtaining a response for the query. In an embodiment, the query engine 110 is configured to convert a voice query to a text form for sending the query to the server 200.

The query engine 110 is configured to retrieve information related to at least one event corresponding to at least one second IoT device 100a-100n in the IoT network. The at least one event corresponding to the at least one second IoT device 100a-100n is a function such as displaying a video, monitoring addition/removal of an item, etc. supporting by the second IoT device 100a-100n. In an embodiment, the information related to the at least one event includes at least one of: a list of identifiers of IoT devices used during the at least one event, an event Identifier (ID), a person involved in the at least one event, a category of the at least one event, actions performed in the event, an intent of the at least one event, an application used during the at least one event, a time stamp of the at least one event, and a metadata of the at least one event.

In an embodiment, the query engine 110 is configured to identify the at least one second IoT device 100a-100n in the IoT network semantically related to the query. In an embodiment, the query engine 110 is configured to extract a plurality of features from the query. Further, the query engine 110 is configured to identify the at least one second IoT device 100a-100n in the IoT network by semantically matching the plurality of features with information of the at least one second IoT device 100a-100n. The plurality of features includes a subject, an intent, a time in the query. The query engine 110 is configured to detect the at least one event corresponding to the at least one second IoT device 100a-100n within a temporal window. An example for the time window is a time in between 4 o' clock and 8 o' clock. Further, the query engine 110 is configured to retrieve the information related to the at least one event from the at least one second IoT device 100a-100n based on the temporal window.

In an embodiment, the query engine 110 is configured to detect that no response is received/generated for the query. Further, the query engine 110 is configured to modify the query based on the information related to the at least one event and execute the modified query to provide at least one response to the user. In an embodiment, the query engine 110 is configured to determine a context of the query based on the information related to the at least one event to modify the query. An example of the context is a time, a user intent of the query. Further, the query engine 110 is configured to classify the query based on the user intent and a history associated with the query. An example of the history associated with the query is a response obtained for the query previously. The history associated with the query includes a previous statistics associated with the query. Further, the query engine 110 is configured to bifurcate the query to identify places in the query where the information related to the at least one event can be added. Further, the query engine 110 is configured to augment the query with the information related to the at least one event in the identified places of the query. Further, the query engine 110 is configured to reformulate the augmented query based on the context of the query and the classification of the query using a Machine Learning (ML) based model. In an embodiment, the query engine 110 is configured to send the modified query to the server 200 for obtaining the at least one response for the modified query. Further, the query engine 210 is configured to generate the at least one response for the modified query by executing the modified query. Further, the query engine 210 is configured to send the at least one response for the modified query to the first IoT device 100. Further, the query engine 110 is configured to receive the at least one response for the modified query from the server 200.

In another embodiment, the query engine 210 is configured to generate the at least one response for the query by executing the query. Further, the query engine 110 is configured to send the at least one response to first IoT device 100. The query engine 110 is configured to modify/personalize the at least one response received for the query from the server 200 based on the information related to the at least one event. Further, the query engine 110 is configured to deliver the at least one modified response to the user. In an embodiment, the query engine 110 is configured to classify the query into pre-trained categories for modifying the response received from the server 200. Examples for the pre-trained categories are, but not limited to an actionable query, an inquiry query, a response query etc. Further, the query engine 110 is configured to identify a relevant context of the response to the IoT network and the second IoT device 100a-100n based on a category of the query. Further, the query engine 110 is configured to identify relevant entities in the response based on the category of the query. The relevant entities are entities that configure the response from the server 200. The relevant entities assist in modifying the response from the server 200 based on a temporal context of the second IoT devices 100a-100n. Further, the query engine 110 is configured to segregate the relevant entities. Further, the query engine 110 is configured to resolve dependencies in the response based on the information related to the at least one event, the relevant entities and the relevant context of the response. Further, the query engine 110 is configured to reformulate the response by adding new data obtained due to resolving the dependencies.

In another embodiment, the query engine 210 is configured to generate at least one follow-up query for the query of the user. Further, the query engine 210 is configured to send the at least one follow-up query to the first IoT device 100. The query engine 110 is configured to generate and provide at least one follow-up response for the least one follow-up query to the server 200 based on the information related to the at least one event, upon receiving the least one follow-up query. In an embodiment, the query engine 110 is configured to identify a context and intention of the at least one follow-up query received from the server 200. Further, the query engine 110 is configured to map the identified context and intention with the information related to the at least one event. Further, the query engine 110 is configured to generate the at least one follow-up response to provide an answer to the follow-up query based on the mapping. The query engine 210 is configured to generate the at least one response (also called a final response) for the at least one follow-up response by executing the at least one follow-up response. Further, the query engine 210 is configured to send the at least one response to the first IoT device 100.

In another embodiment, the query engine 110 is configured to detect that the query is related to at least one previous query received from the user based on the information related to the at least one event. Further, the query engine 110 is configured to detect the at least one response provided for the at least one previous query received from the user, in response to detecting that the query is related to the at least one previous query received from the user. Further, the query engine 110 is configured to execute the query to provide at least one follow-up response based on at least one of: the at least one previous query received from the user and the at least one response provided for the at least one previous query.

In another embodiment, the query engine 110 is configured to receive the query. Further, the query engine 110 is configured to perform a first processing of the query within the IoT network based on events occurred in the IoT network over a pre-defined time. In an embodiment, the first processing is performing for modifying the query or generating the follow-up response. Parallelly, the query engine 210 is configured to perform a second processing of the query. In an embodiment, the second processing is performing for generating the response for the query/modified query or generating the follow-up query. Further, the query engine 110 is configured to feed an output of the first processing to the second processing for assisting the server (200) in preparing the response to the query.

The memory 120-220 may include non-volatile storage elements. Examples of such non-volatile storage elements may include magnetic hard discs, optical discs, floppy discs, flash memories, or forms of an Electrically Programmable Memory (EPROM) or an Electrically Erasable and Programmable Memory (EEPROM).

In addition, the memory 120-220 may, in some examples, be considered a non-transitory storage medium. The term “non-transitory” may indicate that the storage medium is not embodied in a carrier wave or a propagated signal. However, the term “non-transitory” should not be interpreted that the memory 120-220 is non-movable. In some examples, the memory 120-220 can be configured to store larger amounts of information than the memory 120-220 respectively. In certain examples, a non-transitory storage medium may store data that can, over time, change (e.g., in Random Access Memory (RAM) or cache). In an embodiment, the memory 120 includes a database 121. The database 121 is a micro-service based database which contains knowledge graphs or information sources used to retrieve content related to words in the query for rephrasing the query. The micro-service based database can be represented as a knowledge graph where the query can be rephrased based on the temporal context of the second IoT devices 100a-100n. The database 121 contains query components and user preferences. The user preferences are modeled as a user personalized model in the database 121. The query components are words that can be used to add in the query to create a meaningful query.

The processor 130 is configured to execute instructions stored in the memory 120. The communicator 140 is configured to communicate internally between hardware components in the first IoT device 100. Further, the communicator 140 is configured to facilitate the communication between the first IoT device 100 and the server 200.

The processor 230 is configured to execute instructions stored in the memory 220. The communicator 240 is configured to communicate internally between hardware components in the server 200. Further, the communicator 240 is configured to facilitate the communication between the first IoT device 100 and the at least one second IoT device 100a-100n.

At least one of the plurality of modules may be implemented through the ML model. A function associated with ML may be performed through the memory 120, and the processor 130. The processor 130 may include one or a plurality of processors. At this time, one or a plurality of processors may be a general-purpose processor, such as a Central Processing Unit (CPU), an Application Processor (AP), or the like, a graphics-only processing unit such as a Graphics Processing Unit (GPU), a Visual Processing Unit (VPU), and/or an AI-dedicated processor such as a Neural Processing Unit (NPU). In an embodiment, the one or a plurality of processors control processing of the input data in accordance with a predefined operating rule or ML model stored in the memory 120. The predefined operating rule or ML model is provided through training or learning. Here, being provided through learning means that, by applying a learning algorithm to a plurality of learning data, a predefined operating rule or ML model of a desired characteristic is made. The learning may be performed in an electronic device itself in which the ML according to an embodiment is performed, and/o may be implemented through a separate server/system.

The ML model may consist of a plurality of neural network layers. Each layer has a plurality of weight values, and performs a layer operation through calculation of a previous layer and an operation of a plurality of weights. Examples of neural networks include, but are not limited to, Convolutional Neural Network (CNN), Deep Neural Network (DNN), Recurrent Neural Network (RNN), Restricted Boltzmann Machine (RBM), Deep Belief Network (DBN), Bidirectional Recurrent Deep Neural Network (BRDNN), Generative Adversarial Networks (GAN), and deep Q-networks. The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although the FIG. 1 shows the hardware components of the system 1000 but it is to be understood that other embodiments are not limited thereon. In other embodiments, the system 1000 may include less or more number of components. Further, the labels or names of the components are used only for illustrative purpose and does not limit the scope of the disclosure. One or more components can be combined together to perform same or substantially similar function for handling the query.

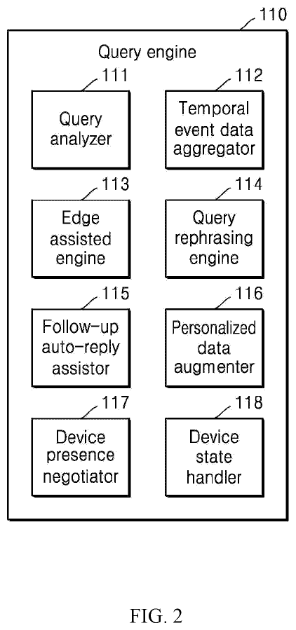

FIG. 2 is a block diagram of a query engine of a first IoT device in a system for handling a query, according to an embodiment of the disclosure.

In an embodiment, the query engine 110 includes a query analyzer 111, a temporal event data aggregator 112, an edge assisted engine 113, a query rephrasing engine 114, a follow-up auto-reply assistor 115, a personalized data augmenter 116, a device presence negotiator 117 and a device state handler 118. An audio sensor such as a microphone of the first IoT device 100 receives the query from the user. Further, the query engine 110 is configured to send the query to the server 200 for obtaining a response for the query. An Automatic Speech Recognition (ASR) engine of the first IoT device 100 converts the voice query to a text form and sends the query to the server 200. The temporal event data aggregator 112 retrieves the information related to the at least one event corresponding to the at least one second IoT device 100a-100n in the IoT network.

The query analyzer 111 identifies the at least one second IoT device 100a-100n in the IoT network semantically related to the query. In an embodiment, the query analyzer 111 extracts the plurality of features from the query. Further, the query analyzer 111 identifies the at least one second IoT device 100a-100n in the IoT network by semantically matching the plurality of features with the information of the at least one second IoT device 100a-100n. The temporal event data aggregator 112 detects the at least one event corresponding to the at least one second IoT device 100a-100n within the temporal window. Further, the temporal event data aggregator 112 retrieves the information related to the at least one event from the at least one second IoT device 100a-100n based on the temporal window.

The query rephrasing engine 114 detects that no response is received/generated for the query. Further, the query rephrasing engine 114 modifies the query based on the information related to the at least one event and executes the modified query to provide at least one response to the user. In an embodiment, the query rephrasing engine 114 determines the context of the query based on the information related to the at least one event to modify the query. Further, the query rephrasing engine 114 classifies the query based on the user intent and the history associated with the query. Further, the query rephrasing engine 114 bifurcates the query to identify the places in the query where the information related to the at least one event can be added. Further, the query rephrasing engine 114 augments the query with the information related to the at least one event in the identified places of the query. Further, the query rephrasing engine 114 reformulates the augmented query based on the context of the query and the classification of the query using the ML based model. In an embodiment, the query rephrasing engine 114 sends the modified query to the server 200 for obtaining the at least one response for the modified query. The query rephrasing engine 114 receives the at least one response for the modified query from the server 200.

The personalized data augmenter 116 modifies/personalizes the at least one response received for the query from the server 200 based on the information related to the at least one event. Further, the personalized data augmenter 116 delivers the at least one modified response to the user. In an embodiment, the personalized data augmenter 116 classifies the query into the pre-trained categories for modifying the response received from the server 200. Further, the personalized data augmenter 116 identifies the relevant context of the response to the IoT network and the second IoT device 100a-100n based on the category of the query. Further, the personalized data augmenter 116 identifies the relevant entities in the response based on the category of the query. Further, the personalized data augmenter 116 segregates the relevant entities. Further, the personalized data augmenter 116 resolves the dependencies in the response based on the information related to the at least one event, the relevant entities and the relevant context of the response. Further, the personalized data augmenter 116 reformulates the response by adding the new data obtained due to resolving the dependencies.

The follow-up auto-reply assistor 115 generates and provides the at least one follow-up response for the least one follow-up query to the server 200 based on the information related to the at least one event, upon receiving the least one follow-up query. In an embodiment, the follow-up auto-reply assistor 115 identifies the context and the intention of the at least one follow-up query received from the server 200. Further, the follow-up auto-reply assistor 115 maps the identified context and the intention with the information related to the at least one event. Further, the follow-up auto-reply assistor 115 generates the at least one follow-up response to provide an answer to the follow-up query based on the mapping.

In another embodiment, the follow-up auto-reply assistor 115 detects that the query is related to at least one previous query received from the user based on the information related to the at least one event. Further, the follow-up auto-reply assistor 115 detects the at least one response provided for the at least one previous query received from the user, in response to detecting that the query is related to the at least one previous query received from the user. Further, the follow-up auto-reply assistor 115 executes the query to provide at least one follow-up response based on at least one of: the at least one previous query received from the user and the at least one response provided for the at least one previous query.

The device presence negotiator 117 finds and reports a direct usage of the second IoT device 100a-100n in the command The device state handler 118 collects a temporal usage history of the second IoT device 100a-100n. In an example, a speaker of the first IoT device 100 delivers the at least one response as an audio output to the user. In another example, a display of the first IoT device 100 delivers the at least one response as a text output to the user.

Although the FIG. 2 shows the hardware components of the query engine 110 but it is to be understood that other embodiments are not limited thereon. In other embodiments, the query engine 110 may include less or more number of components. Further, the labels or names of the components are used only for illustrative purpose and does not limit the scope of the disclosure. One or more components can be combined together to perform same or substantially similar function for handling the query.

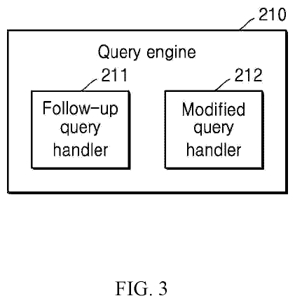

FIG. 3 is a block diagram of a query engine of a server in a system for handling a query, according to an embodiment of the disclosure.

The modified query handler 212 generates the at least one response for the query by executing the query. Further, the modified query handler 212 sends the at least one response to first IoT device 100. In another embodiment, the modified query handler 212 generates the at least one response for the modified query by executing the modified query, in response to receiving the modified query after the query. Further, the modified query handler 212 sends the at least one response for the modified query to the first IoT device 100.

In an embodiment, the follow-up query handler 211 generates the at least one follow-up query for the query of the user. Further, the follow-up query handler 211 sends the at least one follow-up query to the first IoT device 100. In another embodiment, the follow-up query handler 211 generates the at least one response (also called the final response) by executing the at least one follow-up response. Further, the follow-up query handler 211 sends the at least one response to the first IoT device 100.

Although the FIG. 3 shows the hardware components of the query engine 210 but it is to be understood that other embodiments are not limited thereon. In other embodiments, the query engine 210 may include less or more number of components. Further, the labels or names of the components are used only for illustrative purpose and does not limit the scope of the disclosure. One or more components can be combined together to perform same or substantially similar function for handling the query.

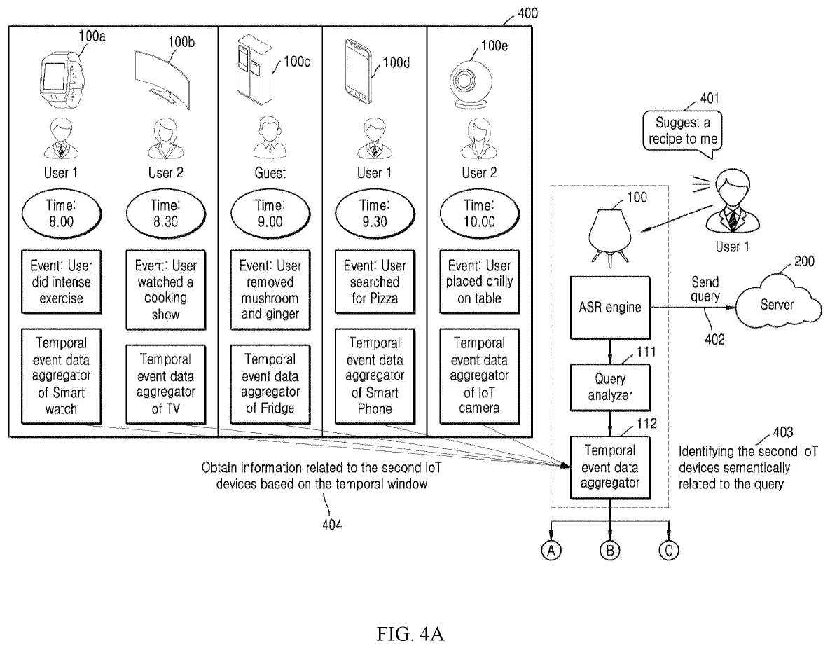

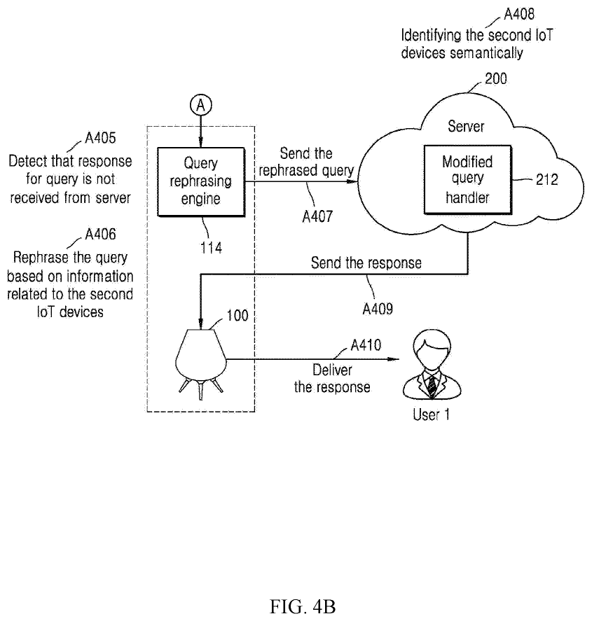

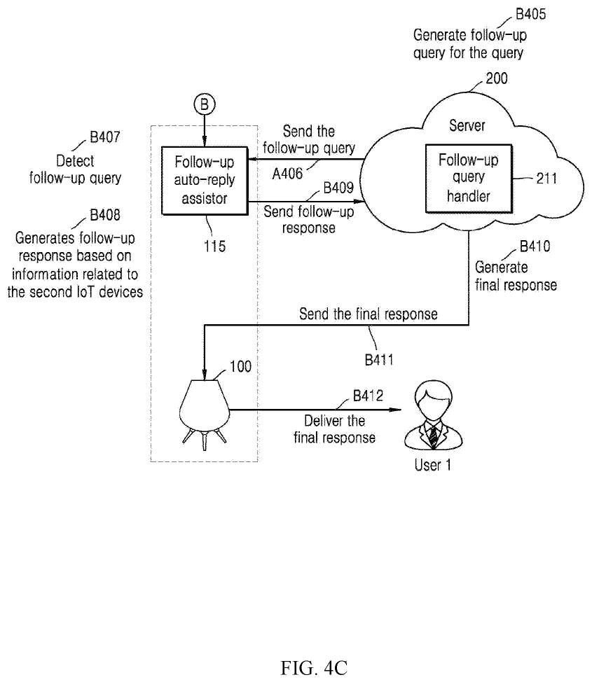

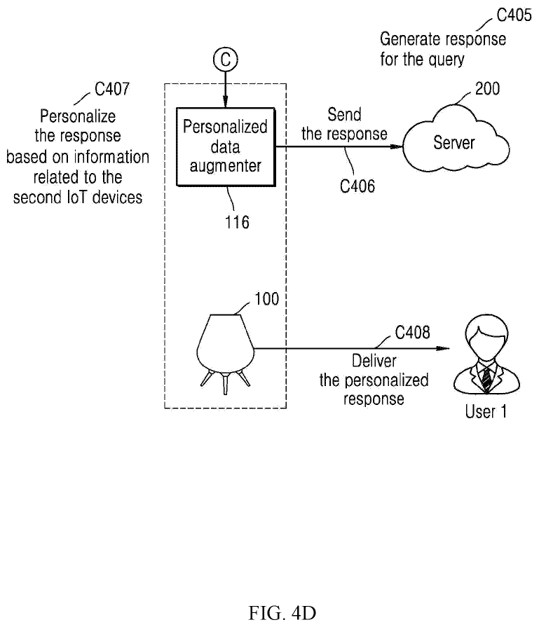

FIGS. 4A, 4B, 4C, and 4D are flow diagrams illustrating a method of handling a query using a system, according to various embodiments of the disclosure.

In FIG. 4A, consider, the user 1 has worn the smart watch 100a and did intense exercise at the time 8-8.29. The temporal event data aggregator of the smart watch 100a records the event of doing intense exercise by the user 1 at the time 8-8.29. Consider, the user 2 has watched a cooking show on the TV 100b at the time 8.30-8.59. The temporal event data aggregator of the TV 100b records the event of watching the cooking show by the user 2 at the time 8.30-8.59.

Consider, the guest user has opened the fridge 100c and removed the mushroom and the ginger from the fridge 100c at the time 9. The temporal event data aggregator of the fridge 100c records the event of removing the mushroom and the ginger from the fridge 100c by the guest user at the time 9. Consider, the user 1 has searched for Pizza using the smart phone 100d at the time 9.30. The temporal event data aggregator of the smart phone 100d records the event of searching for Pizza by the user 1 at the time 9.30. Consider, the user 2 has placed the chilly on the top of a table at the time 10. The temporal event data aggregator of the IoT camera 100e records the event of placed the chilly on the top of a table by the user 2 at the time 9.30. Consider, the user 1 provides the voice query “Suggest me a recipe” to the VA (e.g., first IoT device 100) after the time 9.30.

At operation 401, the method includes receiving the voice query from the user 1. In an embodiment, an audio sensor of the VA (e.g., first IoT device 100) receives the voice query from the user 1. Further, the method includes converting the voice query to the text format. In an embodiment, the ASR engine of the VA (e.g., first IoT device 100) converts the voice query to the text format. At operation 402, the method includes sending the text format of the voice query to the server 200 to generate the response for the voice query. In an embodiment, the ASR engine sends the text format of the voice query to the server 200 to generate the response for the voice query. At operation 403, the method includes identifying the second IoT devices 100a-100e in the IoT network those are semantically related to the voice query. In an embodiment, the query analyzer 111 identifies the second IoT devices 100a-100e semantically related to the voice query.

Further, the method includes detecting the event corresponding to the second IoT devices 100a-100e within the temporal window (e.g. at time 8-10). In an embodiment, the temporal event data aggregator 112 communicates with the temporal event data aggregator of the second IoT devices 100a-100e. Further, the temporal event data aggregator 112 detects the event corresponding to the second IoT devices 100a-100e within the temporal window. At operation 404, the method includes obtaining the information related to the second IoT devices based on the temporal window. In the current example scenario, the information related to the second IoT devices is the recorded information at the temporal event data aggregator of the second IoT devices 100a-100e. In an embodiment, the temporal event data aggregator 112 obtains the information related to the second IoT devices based on the temporal window.

In FIG. 4B, at operation A405, the method includes detecting that the response for the voice query is not received from the server 200 after sending the text format of the voice query to the server 200. In an embodiment, the query rephrasing engine 114 detects that the response for the voice query is not received from the server 200. At operation A406, the method includes rephrasing the text format of the voice query based on the information related to the second IoT devices 100a-100e. In an embodiment, the query rephrasing engine 114 rephrases the text format of the voice query based on the information related to the second IoT devices 100a-100e. At operation A407, the method includes sending the rephrased text form of the voice query to the server 200. In this disclosure, the rephrased text form of the voice query is also called as the rephrased query or modified query. In an embodiment, the query rephrasing engine 114 sends the rephrased query to the server 200.

At operation A408, the method includes generating the response for the rephrased query instead of generating the response for the text form of the query received from the ASR engine. In an embodiment, the modified query handler 212 generates the response for the rephrased query instead of generating the response for the text form of the query received from the ASR engine. At operation A409, the method includes sending the response for the rephrased query to the VA (e.g., first IoT device 100), in response to generating the response for the rephrased query. In an embodiment, the modified query handler 212 sends the response for the rephrased query to the VA (e.g., first IoT device 100), in response to generating the response for the rephrased query. At operation A410, the method includes delivering the response for the rephrased query to the user 1. In an embodiment, the VA (e.g., first IoT device 100) delivers the response for the rephrased query to the user 1 as the text output or the audio output.

In FIG. 4C, at operation B405, the method includes generating the follow-up query for the text form of the query, in response to receiving the text form of the query at the server 200. In an embodiment, the follow-up query handler 211 generates the follow-up query for the text form of the query, in response to receiving the text form of the query at the server 200. At operation B406, the method includes sending the follow-up query to the VA (e.g., first IoT device 100). In an embodiment, the follow-up query handler 211 sends the follow-up query to the VA (e.g., first IoT device 100). At operation B407, the method includes detecting the follow-up query, in response to receiving the follow-up query from the server 200. In an embodiment, the follow-up auto-reply assistor 115 detects the follow-up query, in response to receiving the follow-up query from the server 200. At operation B408, the method includes generating the follow-up response for the follow-up query based on the information related to the second IoT devices 100a-100e. In an embodiment, the follow-up auto-reply assistor 115 generates the follow-up response for the follow-up query based on the information related to the second IoT devices 100a-100e. At operation B409, the method includes sending the follow-up response to the server 200. In an embodiment, the follow-up auto-reply assistor 115 sends the follow-up response to the server 200.

At operation B410, the method includes generating the final response based on the follow-up response when the server 200 is able to define the intent of the user 1 in providing the query. In an embodiment, the follow-up query handler 211 generates the final response based on the follow-up response when the server 200 is able to define the intent of the user 1 in providing the query. The method includes continue communicating with the VA (e.g., first IoT device 100) by sending another follow-up query for the follow-up response and receiving another follow-up response until the server 200 is able to define the intent of the user 1 in providing the query. At operation B411, the method includes sending the final response to the VA (e.g., first IoT device 100). In an embodiment, the follow-up query handler 211 sends the final response to the VA (e.g., first IoT device 100). At operation B412, the method includes delivering the final response to the user 1, in response to receiving the final response from the server 200. In an embodiment, the VA (e.g., first IoT device 100) delivers the final response to the user 1 as the text output or the audio output, in response to receiving the final response from the server 200.

In FIG. 4D, at operation C405, the method includes generating the response for the query when the server 200 is able to define the intent of the user 1, in response to receiving the text form of the query. In an embodiment, the server 200 generates the response for the query when the server 200 is able to define the intent of the user 1, in response to receiving the text form of the query. At operation C406, the method includes sending the response to the VA (e.g., first IoT device 100). In an embodiment, the server 200 sends the response to the VA (e.g., first IoT device 100). At operation C407, the method includes personalizing the response based on the information related to the second IoT devices 100a-100e, in response to receiving the response from the server 200. In an embodiment, the personalized data augmenter 116 personalizes the response based on the information related to the second IoT devices 100a-100e, in response to receiving the response from the server 200. At operation C408, the method includes delivering the personalized response to the user 1. In an embodiment, the VA (e.g., first IoT device 100) delivers the personalized response to the user 1 as the text output or the audio output.

The various actions, acts, blocks, operations, or the like in the flow diagram 400 may be performed in the order presented, in a different order or simultaneously. Further, in some embodiments, some of the actions, acts, blocks, operations, or the like may be omitted, added, modified, skipped, or the like without departing from the scope of the disclosure.

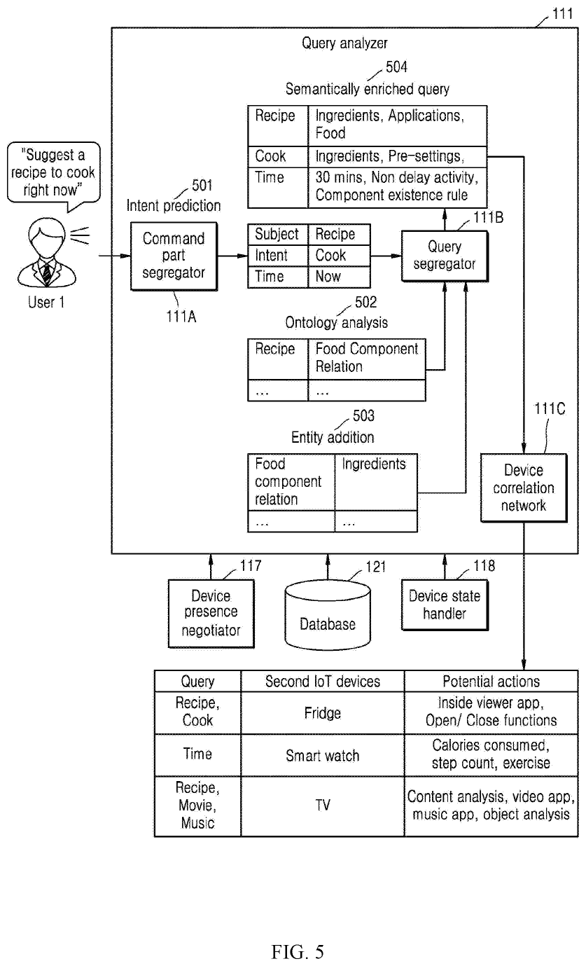

FIG. 5 is a flow diagram illustrating operations in a method performed by a query analyzer of a first IoT device for retrieving information related to events corresponding to second IoT devices in an IoT network, according to an embodiment of the disclosure.

In an embodiment, the query analyzer 111 analyses the query of the user in parallel to determine a correlation of the query with the second IoT devices 100a-100n in the IoT network. Consider, the example scenario where the user provides the voice query “Suggest a recipe to cook right now” to the first IoT device 100. A command part segregator 111A of the query analyzer 111 identifies important keywords and analyses co-relatable parts in the query. The command part segregator 111A segregates (501) important keywords as a subject, an intent and a time by prediction. The command part segregator 111A identifies “Recipe” as the subject. The command part segregator 111A predicts the intent of the user in providing the query as “cook”. Further, the command part segregator 111A detects the time at which the user wants the recipe is “now”. A query enricher 111B of the query analyzer 111 analyses ontology (502) of each word in the query to fit in a logical command model and form relationships like: Recipe→Food Component Relation.

Further, the query enricher 111B populates (503) appropriate entities that fulfils the formed relationships through a device. Further, the query enricher 111B generates (504) a semantically enriched query using the formed relationships, the entities suitable for the formed relationships, and the segregated important keywords in the query. A device correlation network 111C of the query analyzer 111 identifies the second IoT devices 100a-100n that might be required for the query, and potential actions (i.e. possible monitoring actions) supporting by the second IoT devices 100a-100n based on the semantically enriched query and the information providing by the device presence negotiator 117, the database 121 and the device state handler 118. Further, the device correlation network 111C generates an output using the identified second IoT devices 100a-100n that might be required for the query, and potential actions (i.e. possible monitoring actions) supporting by the second IoT devices 100a-100n. Further, the device correlation network 111C provides the output to the temporal event data aggregator 112.

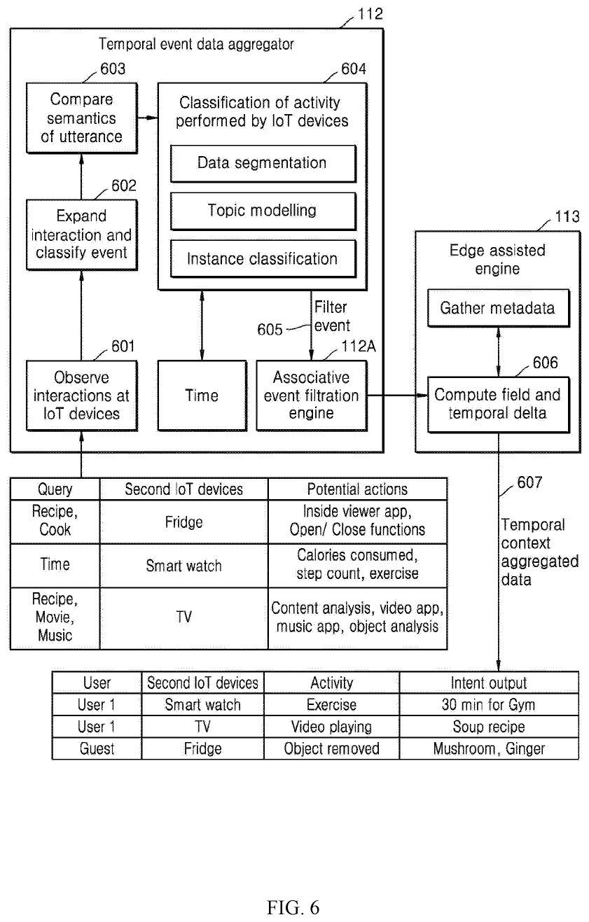

FIG. 6 is a flow diagram illustrating operations in a method performed by a temporal event data aggregator of a first IoT device for retrieving information related to events from a second IoT device based on a temporal window, according to an embodiment of the disclosure.

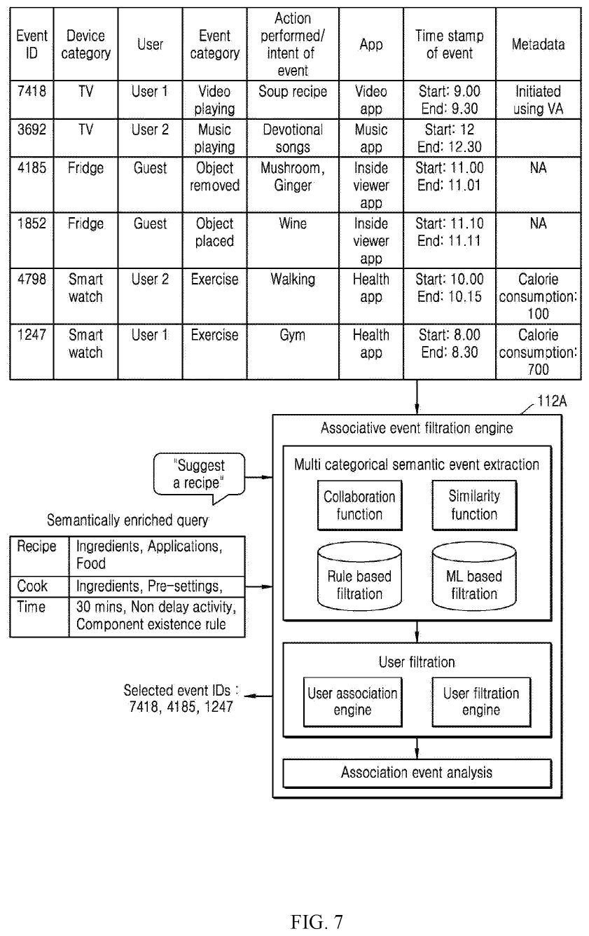

In response to receiving the output from the query analyzer 111, the temporal event data aggregator 112 observes (601) interactions with the second IoT device 100a-100n by communicating to the temporal event data aggregator of the second IoT device 100a-100n. Further, the temporal event data aggregator 112 obtains appropriate activities and actions corresponding to the second IoT device 100a-100n. Further, the temporal event data aggregator 112 expands (602) the interaction and classifies the event. Further, the temporal event data aggregator 112 compares (603) semantics of utterance. Further, the temporal event data aggregator 112 classifies (604) the activity performed by the second IoT device 100a-100n within the temporal window as shown in notation (a) of FIG. 7.

The temporal event data aggregator 112 performs a data segmentation, a topic modelling, and an instance classification for classifying the activity. Further, an associative event filtration engine 112A of the temporal event data aggregator 112 filters (605) and selects the events using based on a temporal relation with the query, query semantics, classified activity and the user who triggered the query. Four types of way the user interacts with the IoT devices are through a single user device (e.g. smartphone, a smart watch, etc.), a virtual assistant, an IoT application user interface and manual operations. The single user device is always used by a single user. Thus, the associative event filtration engine 112A can identify the user of the single user device that involves in the events.

The virtual assistant can identify the user based on a voice or an image of the user while receiving the query from the user. Further, the associative event filtration engine 112A can obtain the user identity from the virtual assistant. The temporal event data aggregator 112 can obtain the user identity based on the user profile that associated with the IoT application user interface. In case of the manual operation, the associative event filtration engine 112A can obtain user identity through the IoT camera that associates with events. If the IoT camera is not available, the associative event filtration engine 112A leverages pre and post activities of the users to associate the user with the event. When the user involved in the event is unknown, for example the user removes the mushroom and ginger from the fridge, then the associative event filtration engine 112A associates the user based on previous/current activities of the user. In an example scenario, the user 1 reading about soup recipe on the smartphone will be associated with the event where “the mushroom and ginger removal” is detected from the fridge around same time. The edge assisted engine 113 of the second IoT device 100a-100n obtains an output from the associative event filtration engine 112A.

Further, the edge assisted engine 113 computes and analyzes (606) a field and a temporal delta by gathering the metadata in the events. The field signifies a category of the query such as health, food, road navigation, etc. The temporal delta signifies a time based events collected on the second IoT devices 100a-100n before receiving the query. Further, the edge assisted engine 113 accumulates the events for a dynamic temporal window depending on a category of the second IoT device 100a-100n, a user usage on the second IoT device 100a-100n and a significance of the event corresponding to the second IoT device 100a-100n. Further, the edge assisted engine 113 generates (607) a temporal context aggregated data includes information regarding the user, second IoT device 100a-100n, the activity performed by the second IoT device 100a-100n in recent past according to the temporal window and a resulting intent output or state change because of that activity. The intent output includes data related to the activities and user, like the way the user did the activity, how long user did the activity, what things user changed in device's state while doing the activity etc.

FIG. 7 is a flow diagram illustrating operations in a method performed by an associative event filtration engine of a first IoT device for filtering the events, according to an embodiment of the disclosure.

The activity performed by the second IoT device 100a-100n within the temporal window is classified as shown in notation (a) of FIG. 7. The activities are classified based on the event ID, the device category, the person involved in the event, the category of the event, the actions performed in the event or the intent of the event, the application used during the event, the time stamp of the start and end of the event, and the metadata of the event.

The associative event filtration engine 112A performs multi categorical semantic event extraction on the classified activities by using a collaboration function and a similarity function. The associative event filtration engine 112A extracts the events from various category of the events from the second IoT device 100a-100n. Further, the associative event filtration engine 112A selects events based on semantic similarity matching between the query and the timestamp of the event. In an embodiment, the associative event filtration engine 112A uses a rule-based filtration or the ML based filtration for selecting the events, where an activity-based selection model is used to perform the ML based filtration. The associative event filtration engine 112A filters the events based on the query derived event similarity and time interpolation. In an embodiment, the associative event filtration engine 112A filters the events based on the user that initiates the query and other activities.

The user association engine of the associative event filtration engine 112A assigns the users for anonymous events. In an embodiment, the user association engine uses a user classifier to assign users to the anonymous events. The user filtration engine of the associative event filtration engine 112A filters the events using the rule based filtration based on a query initiator. Further, the associative event filtration engine 112A performs association event analysis by analyzing the gathered data/fields, and removes unnecessary fields/data based on similarity. Further, the associative event filtration engine 112A provides the selected events to the edge assisted engine 113.

In an example scenario, where the query of the user 1 is “Suggest me a recipe”, and the time of the query is 12.45. With respect to the notation (a) of the FIG. 7, the user 1 and guest user are involved in the events having the event IDs 7418, 4185, 1247. Also, the events having the event IDs 7418, 4185, 1247 are related to the query of the user 1. Therefore, the associative event filtration engine 112A selects the event IDs 7418, 4185, 1247 within the temporal window of time 8.00 to 12.45 from the classified activities.

Consider an example scenario of receiving a message/notification of a coupon code at the smartphone of the user. The associative event filtration engine 112A performs multi categorical semantic event extraction using a query based application data filtering. For example, when query is about food, then applications and message about food content are prioritized, then videos, then text messages regarding food are taken forward. The associative event filtration engine 112A performs user filtration based on the user of the smart phone/application, the query initiator and the query used to filter. The associative event filtration engine 112A performs association event analysis for removing specific application related input data like play/pause/rewind, and extra text in the message.

Consider an example scenario of detecting the user at the kitchen by the IOT camera. The associative event filtration engine 112A performs multi categorical semantic event extraction to identify the current activity of the user. The associative event filtration engine 112A performs user filtration based on the presence of a user in specific location of the home and a proof of operating the device. The associative event filtration engine 112A performs association event analysis on the specific events captured in the camera currently/past.

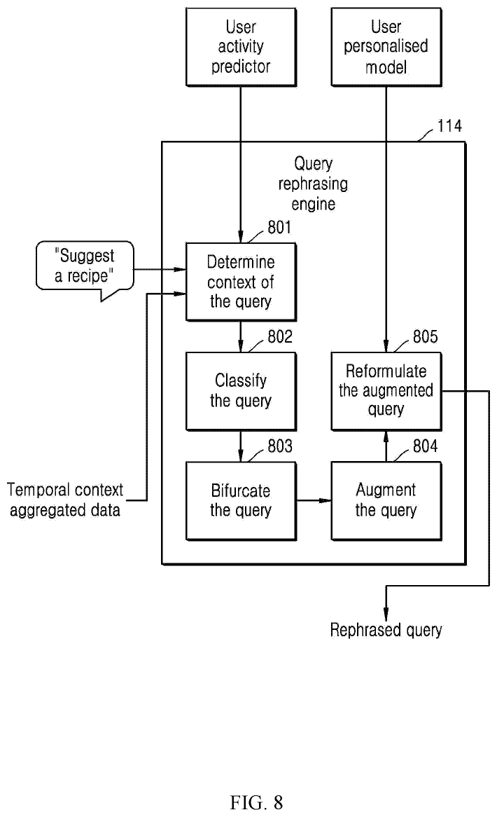

FIG. 8 is a flow diagram illustrating operations in a method performed by the query rephrasing engine of a first IoT device for modifying the query, according to an embodiment of the disclosure.

In response to detecting that the response for the query is not received from the server 200, the query rephrasing engine 114 determines (801) the context of the query using the temporal context aggregated data, the query and a current user activity predicted by a user activity predictor. The user activity predictor predicts is a deep neural network trained using a customized dataset. Further, the query rephrasing engine 114 classifies (802) the query as an incidental query, an associated query, a response query, etc. based on the user intent and associating with the history. Further, the query rephrasing engine 114 bifurcates (803) the query to identify places in the query where the temporal context aggregated data can be added. Further, the query rephrasing engine 114 augments (804) the query with the temporal context aggregated data in the identified places of the query. The query rephrasing engine 114 reformulates (805) the augmented query using a ML based model and user personalization obtained from a user personalized model to generate the rephrased query.

In an embodiment, the query rephrasing engine 114 adds extra relations to the bifurcated query with custom parameters related to entity types obtainable from the second IoT device 100a-100n, services, etc., for augmenting the query. Further, the query rephrasing engine 114 associates the temporal context aggregated data with expanded relation terms and associates them in a hierarchy for further analysis. Further, the query rephrasing engine 114 uses a Deep Neural Network (DNN) to score the added relation from the second IoT device 100a-100n and the association between the temporal context aggregated data and expanded relation terms with the original query and the bifurcated query. Further, the query rephrasing engine 114 removes the data based on query augmentation configurations and a threshold value.

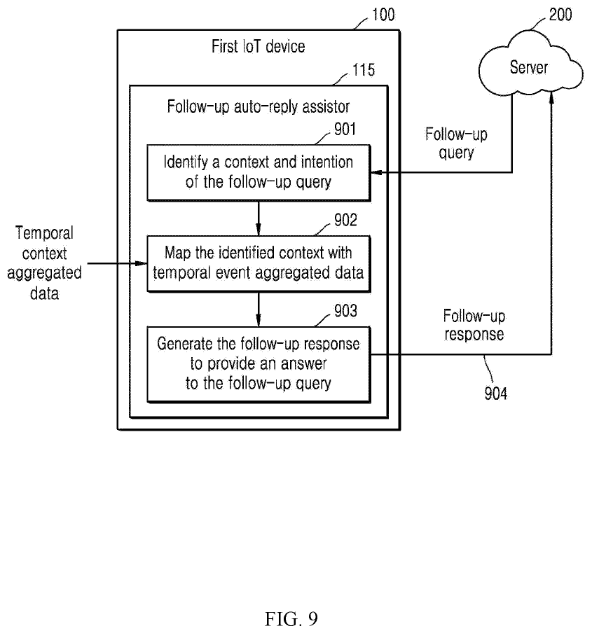

FIG. 9 is a flow diagram illustrating operations in a method performed by a follow-up auto-reply assistor of a first IoT device for providing follow-up responses to a server, according to an embodiment of the disclosure.

In response to receiving the follow-up query at the first IoT device 100 from the server 200, the follow-up auto-reply assistor 115 identifies (901) the context and an intention of the follow-up query. Further, the follow-up auto-reply assistor 115 maps (902) the identified context with the temporal event aggregated data. Further, the follow-up auto-reply assistor 115 generates (903) the follow-up response to provide an answer to the follow-up query. Further, the follow-up auto-reply assistor 115 sends (904) the follow-up response to the server 200.

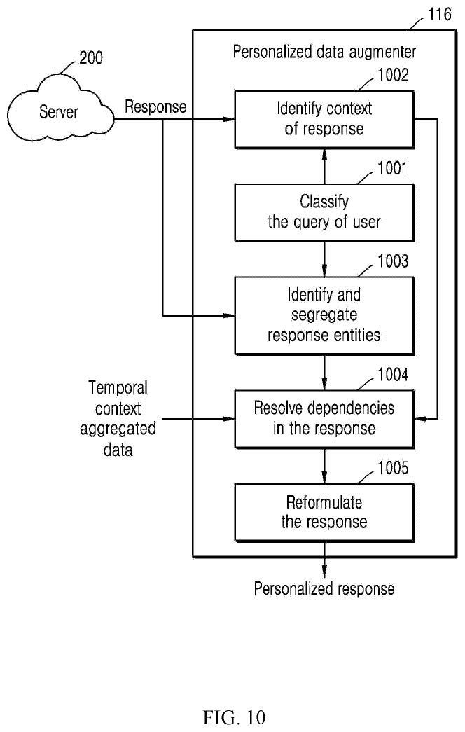

FIG. 10 is a flow diagram illustrating operations in a method performed by a personalized data augmenter of a first IoT device for providing the personalized response to the user, according to an embodiment of the disclosure.

Upon receiving the response or the final response at the first IoT device 100 from the server 200, the personalized data augmenter 116 classifies (1001) the query into pre-trained categories such as actionable query, inquiry query, response query etc. according to what the response would instigate in. Further, the personalized data augmenter 116 identifies (1002) important relevant context of the response to the IoT network and the second IoT device 100a-100n. Further, the personalized data augmenter 116 (1003) identifies and segregates relevant/expandable response entities from the response. Further, the personalized data augmenter 116 resolves (1004) the detected dependencies in the response using the temporal context aggregated data, the relevant/expandable response entities and the relevant context of the response. Further, the personalized data augmenter 116 readjusts and reformulates (1005) the response including the available new data to provide the personalized/modified response.

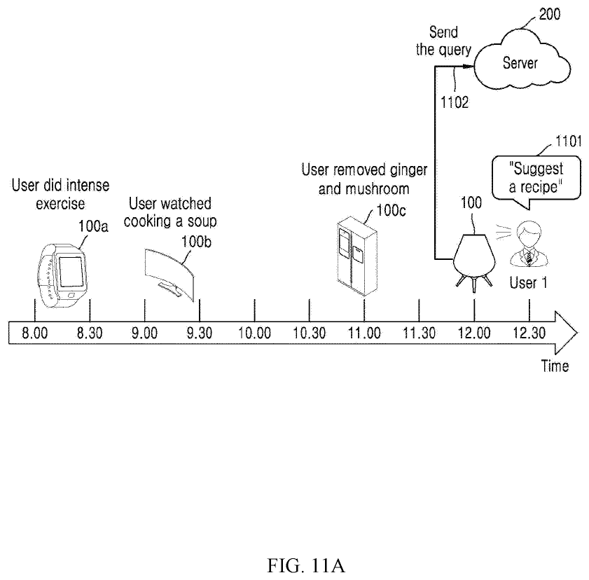

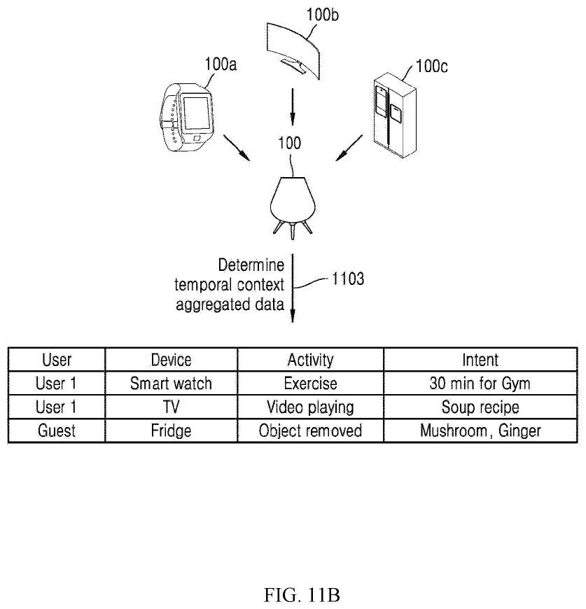

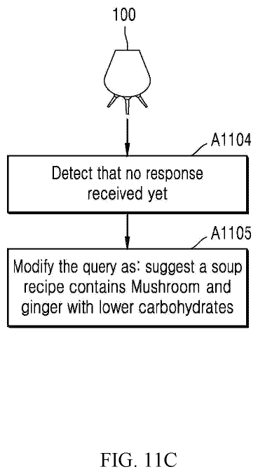

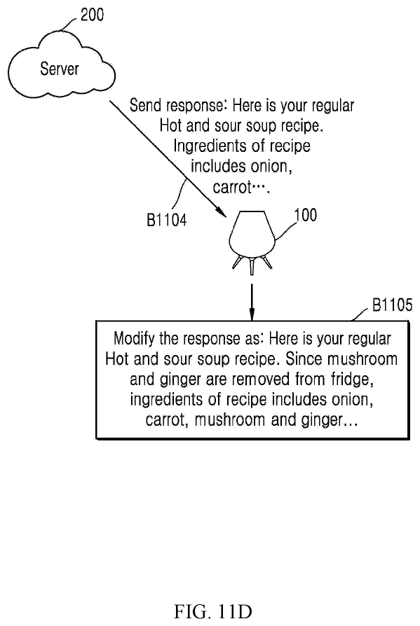

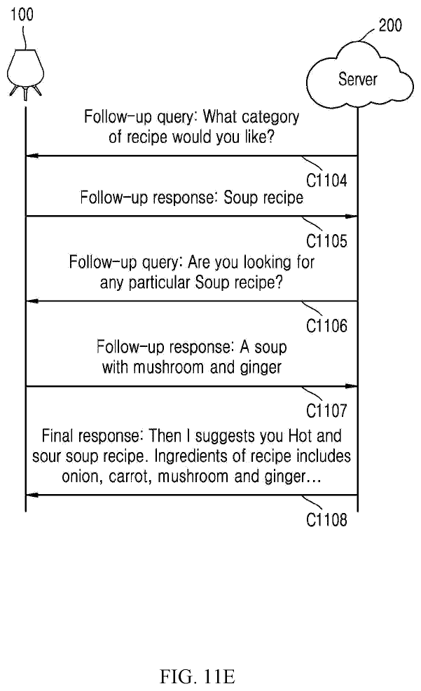

FIGS. 11A, 11B, 11C, 11D, and 11E illustrate an example scenario of handing a query related to suggesting a recipe to a user based on information related to events, according to various embodiments of the disclosure.

In FIG. 11A, consider, the user 1 has worn the smart watch 100a and did intense exercise at the time 8-8.29 as shown in FIG. 11B. The temporal event data aggregator of the smart watch 100a records the event of doing intense exercise by the user 1 at the time 8-8.29. Consider, the user 1 has watched a video of cooking the soup on the TV 100b at the time 9-9.30. The temporal event data aggregator of the TV 100b records the event of watching the video of cooking the soup by the user 1 at the time 9-9.30. Consider, the guest user has opened the fridge 100c and removed the mushroom and the ginger from the fridge 100c at the time 11. The temporal event data aggregator of the fridge 100c records the event of removing the mushroom and the ginger from the fridge 100c by the guest user at the time 11. Consider, the user 1 gives (1101) the query “suggest a recipe to me” to the VA (e.g., first IoT device 100) at time 12.

The VA (e.g., first IoT device 100) sends (1102) the query to the server 200 to obtain the response. Further, the VA (e.g., first IoT device 100) detects that the smart watch 100a, TV 100b and the fridge 100c are the second IoT devices in the IoT network that have the relation with the query. Further, the VA (e.g., first IoT device 100) determines that the events in the day starts from time 8 and the query from the user received at time 12. Therefore, the VA (e.g., first IoT device 100) chooses the temporal window as the time 8-12. Further, the VA (e.g., first IoT device 100) communicates with the temporal event data aggregator of the smart watch 100a, TV 100b and the fridge 100c to obtain information related to the events corresponding to the smart watch 100a, TV 100b and the fridge 100c within the temporal window of time 8-12. Further, the VA (e.g., first IoT device 100) determines that the event corresponding to the smart watch 100a, TV 100b and the fridge 100c are done/probably done by the user 1 based on the information related to the events, in response to obtaining the information related to the events. Further, the VA (e.g., first IoT device 100) determines (1103) the temporal context aggregated data using the information related to the events as shown in FIG. 11B.

In FIG. 11C, consider, the VA (e.g., first IoT device 100) haven't received the response for the query until now from the server 200. The VA (e.g., first IoT device 100) detects (A1104) that no response has received yet from the server 200, as shown in FIG. 11C. Since the user 1 watches the video of cooking the soup, the VA (e.g., first IoT device 100) detects that the user is preferred to cook the soup. Since the user 1 did intense exercise, the VA (e.g., first IoT device 100) detects that the user is health conscious. Since the guest user taken the mushroom and ginger from the fridge 100c, the VA (e.g., first IoT device 100) detects that the user wishes to cook using the mushroom and ginger. Further, the VA (e.g., first IoT device 100) modifies (A1105) the query as “suggest a soup recipe to me that contains mushroom and ginger with lower carbohydrates” based on the user preference and the temporal context aggregated data.

In FIG. 11D, consider, the VA (e.g., first IoT device 100) receives (B1104) the response “Here is your regular Hot and sour soup recipe. Ingredients of recipe includes onion, carrot . . . .” for the query from the server 200, as shown in FIG. 11D. Since the user 1 watches the video of cooking the soup, the VA (e.g., first IoT device 100) detects that the user is preferred to cook the soup. Since the user 1 did intense exercise, the VA (e.g., first IoT device 100) detects that the user is health conscious. Since the guest user taken the mushroom and ginger from the fridge 100c, the VA (e.g., first IoT device 100) detects that the user wishes to cook using the mushroom and ginger. Further, the VA (e.g., first IoT device 100) modifies (B1105) the response as “Here is your regular Hot and sour soup recipe. Since mushroom and ginger are removed from fridge, ingredients of recipe include onion, carrot, mushroom and ginger . . . .” based on the user preference and the temporal context aggregated data.

In FIG. 11D, consider, the VA (e.g., first IoT device 100) receives (C1104) the follow-up query “What category of recipe would you like?” for the query from the server 200, as shown in FIG. 11E. Since the user 1 watches the video of cooking the soup, the VA (e.g., first IoT device 100) detects that the user is preferred to cook the soup. Further, the VA (e.g., first IoT device 100) generates and sends (C1105) the follow-up response “Soup recipe” for the follow-up query to the server 200. Further, the server 200 sends (C1106) the follow-up query “Are you looking for any particular Soup recipe?” for the follow-up response to the VA (e.g., first IoT device 100). Since the guest user taken the mushroom and ginger from the fridge 100c, the VA (e.g., first IoT device 100) detects that the user wishes to cook using the mushroom and ginger. Further, the VA (e.g., first IoT device 100) generates and sends (C1107) the follow-up response “a soup with mushroom and ginger” for the follow-up query to the server 200. Further, the server 200 defines the intent of the user based on the follow-up response from the VA (e.g., first IoT device 100). Further, the server 200 generates and send (C1108) the final response “Then I suggest your Hot and sour soup recipe. Ingredients of recipe include onion, carrot, mushroom and ginger . . . .” to the VA (e.g., first IoT device 100).

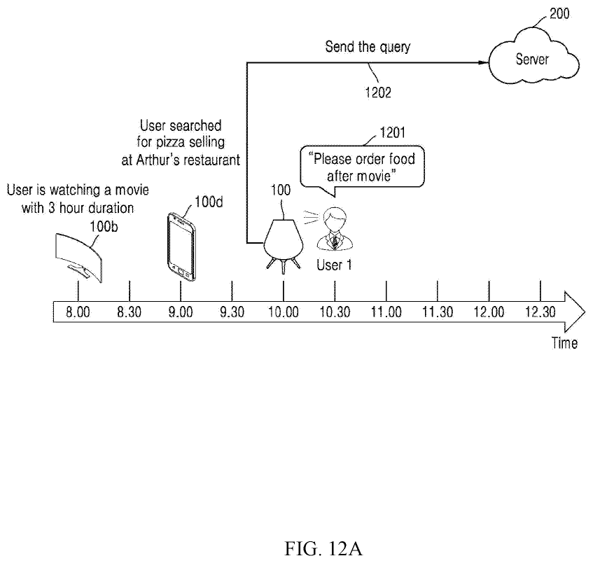

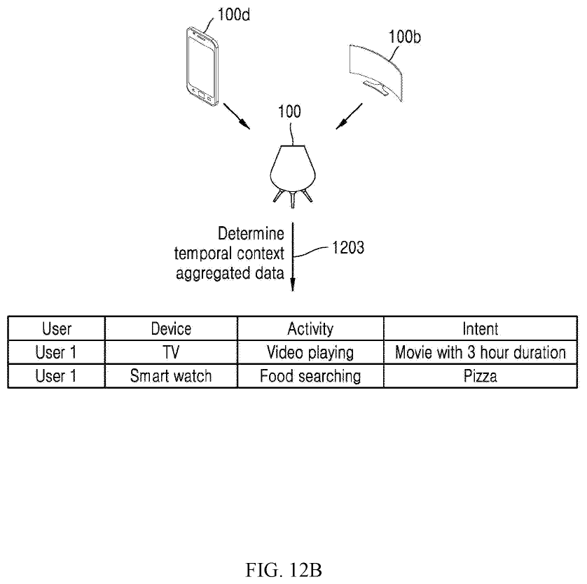

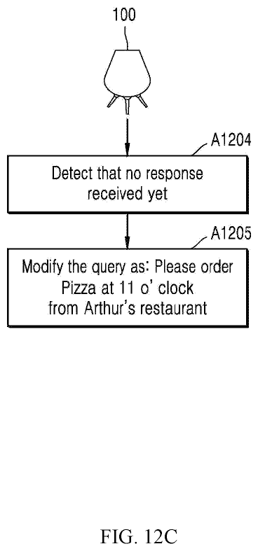

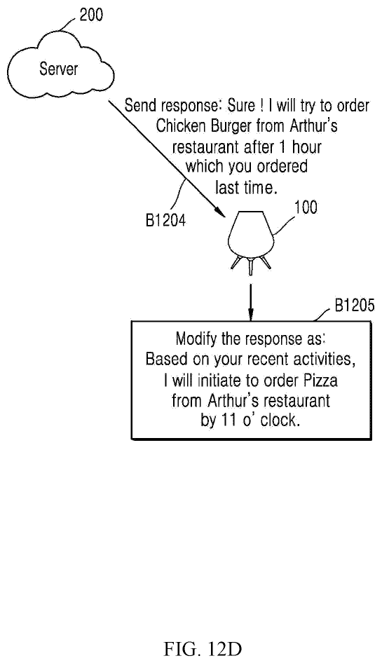

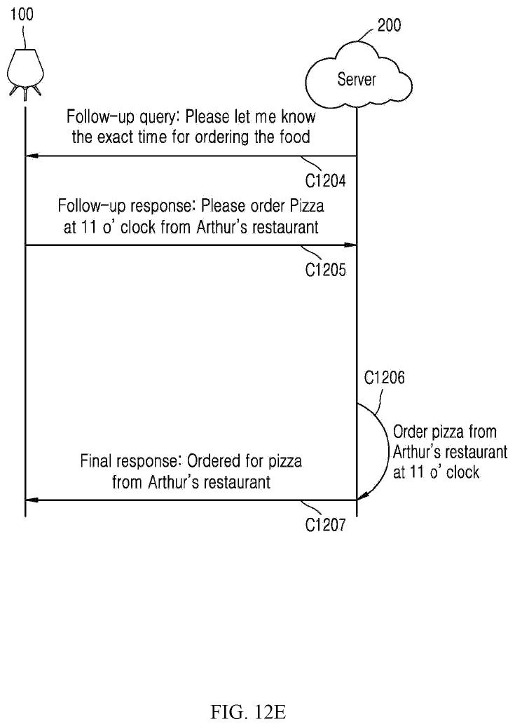

FIGS. 12A, 12B, 12C, 12D, and 12E illustrate an example scenario of handing a query related to ordering a food for a user based on information related to events, according to various embodiments of the disclosure.

In FIG. 12A, consider, the user 1 has started watching the movie of duration of 3 hours at the time 8, as shown in FIG. 12A. The temporal event data aggregator of the TV 100b records the event of watching the movie by the user 1 at the time 8 and the duration of movie as 3 hours. Consider, the user 1 has searched for Pizza selling at Arthur's restaurant using the smart phone 100d at the time 9. The temporal event data aggregator of the smart phone 100d records the event of searching for Pizza by the user 1 at the time 9. Consider, the user 1 gives (1201) the query “Please order food after movie” to the VA (e.g., first IoT device 100) at time 10.

The VA (e.g., first IoT device 100) sends (1202) the query to the server 200 to obtain the response. Further, the VA (e.g., first IoT device 100) detects that the smart phone 100d, and the TV 100b are the second IoT devices in the IoT network that have the relation with the query. Further, the VA (e.g., first IoT device 100) determines that the events in the day starts from time 8 and the query from the user received at time 10. Therefore, the VA (e.g., first IoT device 100) chooses the temporal window as the time 8-10. Further, the VA (e.g., first IoT device 100) communicates with the temporal event data aggregator of the smart phone 100d, and the TV 100b to obtain information related to the events corresponding to the smart phone 100d, and the TV 100b within the temporal window of time 8-10. Further, the VA (e.g., first IoT device 100) determines that the event corresponding to the smart phone 100d, and the TV 100b are done by the user 1 based on the information related to the events, in response to obtaining the information related to the events. Further, the VA (e.g., first IoT device 100) determines (1203) the temporal context aggregated data using the information related to the events as shown in FIG. 12B.

In FIG. 12C, consider, the VA (e.g., first IoT device 100) haven't received the response for the query until now from the server 200. The VA (e.g., first IoT device 100) detects (A1204) that no response has received yet from the server 200, as shown in FIG. 12C. Since the user 1 has starts watching the movie with duration 3 hour from time 8, the VA (e.g., first IoT device 100) detects that the user is preferred to order food at time 11. Since the user 1 has searched for the Pizza selling at the Arthur's restaurant, the VA (e.g., first IoT device 100) detects that the user is preferred to order the Pizza from the Arthur's restaurant. Further, the VA (e.g., first IoT device 100) modifies (A1205) the query as “Please order Pizza at 11 o' clock from Arthur's restaurant” based on the user preference and the temporal context aggregated data.

In FIG. 12D, consider, the VA (e.g., first IoT device 100) receives (B1204) the response “Sure! I will try to order Chicken Burger from Arthur's restaurant after 1 hour which you ordered last time” for the query from the server 200, as shown in FIG. 12D. Since the user 1 has started watching the movie with the duration 3 hour from the time 8, the VA (e.g., first IoT device 100) detects that the user is preferred to order the food at the time 11. Since the user 1 has searched for the Pizza selling at the Arthur's restaurant, the VA (e.g., first IoT device 100) detects that the user prefers to order the Pizza from the Arthur's restaurant. Further, the VA (e.g., first IoT device 100) modifies (B1205) the response as “Based on your recent activities, I will initiate to order Pizza from Arthur's restaurant by 11 o' clock” based on the user preference and the temporal context aggregated data. Further, the VA (e.g., first IoT device 100) is configured to order the Pizza from Arthur's restaurant at 11 o' clock.

In FIG. 12E, consider, the VA (e.g., first IoT device 100) receives (C1204) the follow-up query “Please let me know the exact time for ordering the food” for the query from the server 200, as shown in FIG. 12E. Since the user 1 has started watching the movie with the duration 3 hour from the time 8, the VA (e.g., first IoT device 100) detects that the user is preferred to order the food at the time 11. Further, the VA (e.g., first IoT device 100) generates the follow-up response “Please order food at 11 o' clock” for the follow-up query. Since the user 1 has searched for the Pizza selling at the Arthur's restaurant, the VA (e.g., first IoT device 100) detects that the user is preferred to order the Pizza from the Arthur's restaurant. Further, the VA (e.g., first IoT device 100) modifies the follow-up response as “Please order Pizza at 11 o' clock from Arthur's restaurant” for the follow-up query. Further, the VA (e.g., first IoT device 100) sends (C1205) the modified follow-up response “Please order Pizza at 11 o' clock from Arthur's restaurant” to the server 200. Further, the server 200 defines the intent of the user based on the follow-up response from the VA (e.g., first IoT device 100). Further, the server 200 is configured to order (C1206) the Pizza from Arthur's restaurant at 11 o' clock. In response to ordering the Pizza from Arthur's restaurant at 11 o' clock, the server 200 sends (C1207) the final response “Ordered for pizza from Arthur's restaurant” to the VA (e.g., first IoT device 100).

The embodiments disclosed herein can be implemented using at least one software program running on at least one hardware device and performing network management functions to control the elements.

While the disclosure has been shown and described with reference to various embodiments thereof, it will be understood by those skilled in the art that various changes in form and details may be made therein without departing from the spirit and scope of the disclosure as defined by the appended claims and their equivalents.

1. A method for handling a query in an Internet of Things (IoT) network, the method comprising:
receiving, by a first IoT device in the IoT network, the query from a user of the first IoT device;
retrieving, by the first IoT device, information related to at least one event corresponding to at least one second IoT device in the IoT network; and
generating, by the first IoT device, based on the information related to the at least one event, at least one of:
a modified query for the received query,
at least one modified response corresponding to at least one response received by the first IoT device, or
at least one follow-up response corresponding to a follow-up query received by the first IoT device.

2. The method of claim 1, wherein the retrieving, by the first IoT device, of the information related to the at least one event, comprises:
identifying, by the first IoT device, the at least one second IoT device in the IoT network semantically related to the query received from the first IoT device;
detecting, by the first IoT device, the at least one event corresponding to the at least one second IoT device within a temporal window; and
retrieving, by the first IoT device, the information related to the at least one event from the at least one second IoT device based on the temporal window.

3. The method of claim 2, wherein the identifying, by the first IoT device, of the at least one second IoT device in the IoT network semantically related to the query received from the first IoT device, comprises:
extracting, by the first IoT device, a plurality of features from the query; and
identifying, by the first IoT device, the at least one second IoT device in the IoT network by semantically matching the plurality of features with information of the at least one second IoT device.

4. The method of claim 1, wherein the information related to the at least one event comprises at least one of:
a list of identifiers of IoT devices used during the at least one event;
a person involved in the at least one event;
a category of the at least one event, actions performed in the event;
an intent of the at least one event;
an application used during the at least one event;
a time stamp of the at least one event; or
a metadata of the at least one event.

5. The method of claim 1, wherein the generating, by the first IoT device, of the modified query for the received query based on the information related to the at least one event, comprises:
modifying, by the first IoT device, the query based on the information related to the at least one event; and
executing, by the first IoT device, the modified query to provide at least one response to the user.

6. The method of claim 1, wherein the generating, by the first IoT device, of the at least one modified response to the user corresponding to the at least one response received by the first IoT device based on the information related to the at least one event, comprises:
receiving, by the first IoT device, the at least one response for the query;
modifying, by the first IoT device, the at least one response received for the query based on the information related to the at least one event; and
delivering, by the first IoT device, the at least one modified response to the user.

7. The method of claim 1, wherein the generating, by the first IoT device, of the at least one follow-up response corresponding to the follow-up query received by the first IoT device based on the information related to the at least one event, comprises:
sending, by the first IoT device, the query to a server;
receiving, by the first IoT device, at least one follow-up query from the server;
providing, by the first IoT device, the at least one follow-up response for the least one follow-up query to the server based on the information related to the at least one event; and
providing, by the first IoT device, at least one response to the user in response to receiving at least one response from the server, wherein the server (200) sends the at least one response to the first IoT device by executing the at least one follow-up response.

8. The method of claim 5, wherein the modifying, by the first IoT device, of the query based on the information related to the at least one event, comprises:
determining, by the first IoT device, a context of the query based on the information related to the at least one event;
classifying, by the first IoT device, the query based on a user intent and a history associated with the query;
bifurcating, by the first IoT device, the query to identify places in the query where the information related to the at least one event can be added;
augmenting, by the first IoT device, the query with the information related to the at least one event in the identified places of the query; and
reformulating, by the first IoT device, the augmented query based on the context of the query and the classification of the query using a machine learning based model.

9. The method of claim 7, wherein the providing, by the first IoT device, of the at least one follow-up response for the least one follow-up query to the server based on the information related to the at least one event, comprises:
identifying, by the first IoT device, a context and intention of the at least one follow-up query received from the server;
mapping, by the first IoT device, the identified context and intention with the information related to the at least one event; and
generating, by the first IoT device, the at least one follow-up response to provide an answer for the follow-up query to the server based on the mapping.

10. The method of claim 6, wherein the modifying, by the first IoT device, of the at least one response received for the query based on the information related to the at least one event, comprises:
classifying, by the first IoT device, the query into pre-trained categories;
identifying, by the first IoT device, a relevant context of the response to the IoT network and the second IoT device based on a category of the query;
identifying, by the first IoT device, relevant entities in the response based on the category of the query;
segregating, by the first IoT device, the relevant entities;
resolving, by the first IoT device, dependencies in the response based on the information related to the at least one event, the relevant entities and the relevant context of the response; and
reformulating, by the first IoT device, the response by adding new data obtained due to resolving the dependencies.

11. A first Internet of Things (IoT) device for handling a query in an IoT network, the first IoT device comprising:
a memory;
a processor; and
a query engine, coupled to the memory and the processor, configured to:
receive the query from a user of the first IoT device,
retrieve information related to at least one event corresponding to at least one second IoT device in the IoT network, and
generate based on the information related to the at least one event, at least one of:
a modified query for the received query,
at least one modified response corresponding to at least one response received by the first IoT device, and
at least one follow-up response corresponding to a follow-up query received by the first IoT device.

12. The first IoT device of claim 11, wherein the retrieving of the information related to the at least one event, comprises:
identify the at least one second IoT device in the IoT network semantically related to the query received from the first IoT device;
detect the at least one event corresponding to the at least one second IoT device within a temporal window; and
retrieve the information related to the at least one event from the at least one second IoT device based on the temporal window.

13. The first IoT device of claim 12, wherein the identifying of the at least one second IoT device in the IoT network semantically related to the query received from the first IoT device, comprises:
extract a plurality of features from the query; and
identify the at least one second IoT device in the IoT network by semantically matching the plurality of features with information of the at least one second IoT device.

14. The first IoT device of claim 11, wherein the information related to the at least one event comprises at least one of:
a list of identifiers of IoT devices used during the at least one event;
a person involved in the at least one event;
a category of the at least one event, actions performed in the event;
an intent of the at least one event;
an application used during the at least one event;
a time stamp of the at least one event; or
a metadata of the at least one event.

15. The first IoT device of claim 11, wherein the generating of the modified query for the received query based on the information related to the at least one event, comprises:
modify the query based on the information related to the at least one event; and
execute the modified query to provide at least one response to the user.

16. The first IoT device of claim 11, wherein the generating of the at least one modified response to the user corresponding to the at least one response received by the first IoT device based on the information related to the at least one event, comprises:
receive the at least one response for the query;
modify the at least one response received for the query based on the information related to the at least one event; and
deliver the at least one modified response to the user.

17. The first IoT device of claim 11, wherein the generating of the at least one follow-up response corresponding to the follow-up query received by the first IoT device based on the information related to the at least one event, comprises:
send the query to a server;
receive at least one follow-up query from the server;
provide the at least one follow-up response for the least one follow-up query to the server based on the information related to the at least one event; and
provide at least one response to the user in response to receiving at least one response from the server, wherein the server sends the at least one response to the first IoT device by executing the at least one follow-up response.

18. The first IoT device of claim 15, wherein the modifying of the query based on the information related to the at least one event, comprises:
determine a context of the query based on the information related to the at least one event;
classify the query based on a user intent and a history associated with the query;
bifurcate the query to identify places in the query where the information related to the at least one event can be added;
augment the query with the information related to the at least one event in the identified places of the query; and
reformulate the augmented query based on the context of the query and the classification of the query using a machine learning based model.

19. The first IoT device of claim 17, wherein the providing of the at least one follow-up response for the least one follow-up query to the server based on the information related to the at least one event, comprises:
identify a context and intention of the at least one follow-up query received from the server;
map the identified context and intention with the information related to the at least one event; and
generate the at least one follow-up response to provide an answer for the follow-up query to the server based on the mapping.

20. A method for handling a query in an Internet of Things (IoT) network, the method comprising:
receiving, by a first IoT device in the IoT network, a query;
performing, by the first IoT device, a first processing of the query within the IoT network based on events occurred in the IoT network over a pre-defined time;
performing, by a server, a second processing of the query; and
feeding, by the first IoT device, an output of the first processing to the second processing for assisting the server in preparing a response to the query.
